(19) United States
(12) Patent Application Publication
(10) Pub. No.: US 2025/0376012 A1
(43) Pub. Date: Dec. 11, 2025

(54) VEHICLE DOORS

(71) Applicant: TOYOTA JIDOSHA KABUSHIKI KAISHA, Toyota-shi Aichi-ken (JP)

(72) Inventor: Hideyuki NAKANO, Gotemba-shi Shizuoka-ken (JP)

(73) Assignee: TOYOTA JIDOSHA KABUSHIKI KAISHA, Toyota-shi Aichi-ken (JP)

(21) Appl. No.: 19/225,442

(22) Filed: Jun. 2, 2025

(30) Foreign Application Priority Data
Jun. 5, 2024 (JP) 2024-091796

(51) Int. Cl. B60J 5/04

(52) U.S. Cl. CPC B60J 5/0448; B60J 5/0429; B60J 5/0444

(57) ABSTRACT

A pair of extensions is provided at one end and the other end of the interior of a door 100. A bar-shaped door beam is fixed between both ends to the pair of extensions to reinforce the door. An inner panel that is inside the door 100 and constitutes the interior side of the door. A protective member provided inside the door. The protective member is provided at a position corresponding to the door beam 20 on the inner panel that constitutes the interior side of the door.

### CROSS REFERENCE TO RELATED APPLICATION

This application claims priority to Japanese Patent Application No. 2024-091796 filed on Jun. 5, 2024, which is incorporated herein by reference in its entirety including the specification, claims, drawings, and abstract.

### TECHNICAL FIELD

The present disclosure relates to a vehicle door which is reinforced by door beams.

### BACKGROUND

Vehicle doors are opened and closed when passengers enter and exit the vehicle. In a vehicle door, the outer panel and the inner panel are placed at a predetermined interval. Therefore, vehicle doors have a certain degree of thickness. Then, in order to increase the door strength against side impact, door beam is provided in the inner space of the door as a reinforcement member.

### CITATION LIST

PATENT LITERATURE JP2015-113053A

### SUMMARY

A door beam is fixed at the front side and at both ends at the rear side inside the door. The door beam may be destroyed at both fixed ends during a side impact due to a lateral collision. If one end of the door beam is disconnected, the free end of the door beam may move inward and collide with the inner panel, possibly breaking the inner panel.

The vehicle door of the present disclosure includes a pair of extensions, a bar-shaped door beam, and a protective member. The pair of extensions are located between one end and the other end of the interior of the door. The bar-shaped door beam is fixed at both ends to the pair of extensions and reinforces the door. The protective member which is provided inside the door, and the protective member is provided at a location corresponding to the door beam on the inner panel which constitutes the interior side of the door.

The protective member may have an opposing recess in the portion facing the door beam.

The protective member may be box-shaped with an interior cavity.

The protective member may be made of resin.

According to the vehicle door of the present disclosure, a protective member is provided. Therefore, it can effectively prevent the tip of the door beam 20 from breaking the inner panel 14 in the event of a side impact.

### BRIEF DESCRIPTION OF DRAWINGS

Embodiment(s) of the present disclosure will be described based on the following figures, wherein:

FIG. 1 is a figure showing a schematic view of the interior of the door by removing the outer panel of the rear right side door,

FIG. 2 is a schematic diagram showing the appearance of the outer panel,

FIG. 3 is a diagrammatic diagram showing the positional relationship between the door beam and the protective member,

FIG. 4 is a figure showing B-B cross section in FIG. 1,

FIG. 5 is a figure showing C-C cross section in FIG. 1,

FIG. 6A is a figure showing the configuration of the protective member with a front view,

FIG. 6B is a figure showing the configuration of the protective member with a back view,

FIG. 6C is a figure showing the configuration of the protective member with a side view.

### DESCRIPTION OF EMBODIMENTS

Embodiments of the present disclosure are described below with reference to the drawings. The following embodiments are not intended to limit the present disclosure, and configurations that selectively combine multiple examples are also included in the present disclosure.

### “Door Configuration”

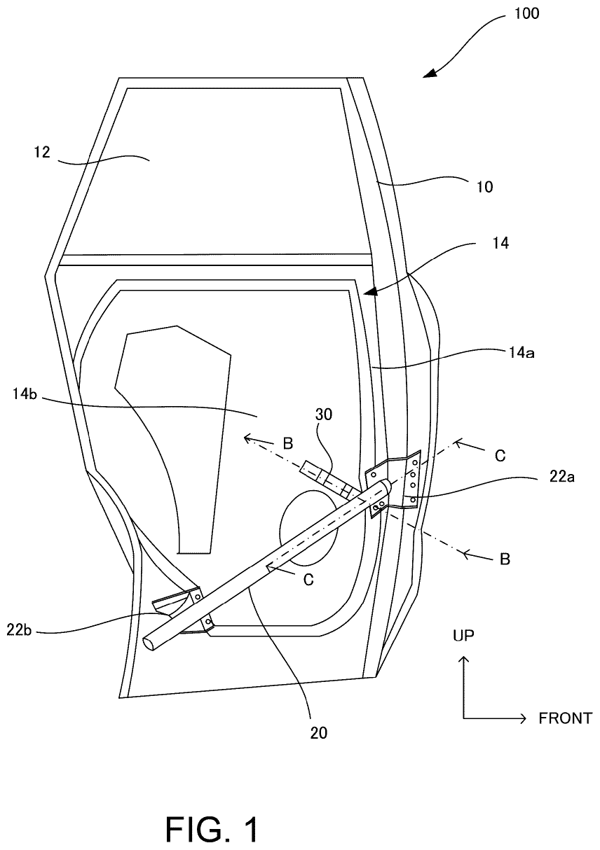

FIG. 1 shows a schematic view of the interior of the door by removing the outer panel of the rear right side of the door 100.

The door 100 is rectangular in overall shape and has a frame 10 surrounding its periphery. At the top of the door 100, a window 12 in which window glass is disposed. Below the window 12, an inner panel 14 that constitutes the interior side of the door 100 is disposed.

The inner panel 14 includes a perimeter portion 14a and a recessed portion 14b. The recessed portion 14b provided inside the perimeter portion 14a and is recessed toward the interior of the vehicle.

One end of the door beam 20 is fixed to the lower front side of the perimeter portion 14a and the other end is fixed to the middle rear side of the perimeter portion 14a. The door beam 20 traverses the recessed portion 14b.

The front end of the door beam 20 is secured to the perimeter portion 14a via a front extension 22a and the rear end of the door beam 20 is secured to the perimeter portion 14a via a rear extension 22b.

The front extension 22a and the rear extension 22b are a pair of extensions 22. The front extension 22a and the rear extension 22b are plate-shaped members. The front extension 22a and rear extension 22b have a semi-cylindrical recess at one end, which accommodates the door beam 20 that has cylindrical shape. The inner panel 14, front extension 22a, and rear extension 22b may be made of a metallic material such as steel. Door beam 20 is a pipe-like skeletal member and may be made of steel. The front extension 22a and rear extension 22b, the door beam 20, and the perimeter portion 14a can be fixed by spot welding or other means. Bolting or other fixing methods can also be used for these fixations.

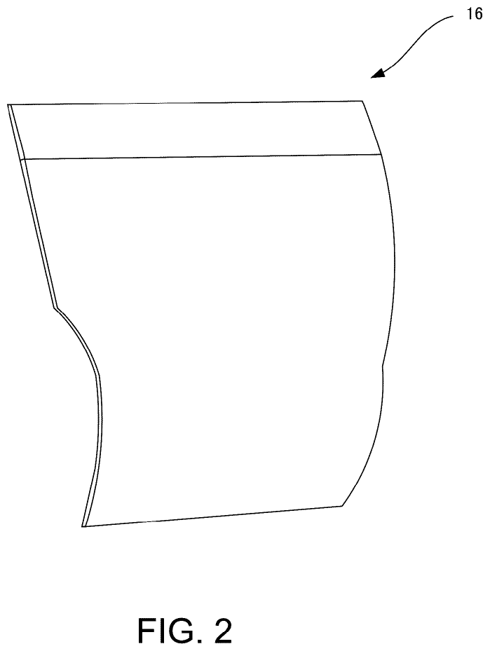

FIG. 2 is a schematic view of the outer panel 16. As shown, the outer panel 16 has a shape corresponding that of the inner panel 14. The outer panel 16 bulges outward. Therefore, by closing the outer side of the inner panel 14 with the outer panel 16, a door beam 20 with some length can be arranged.

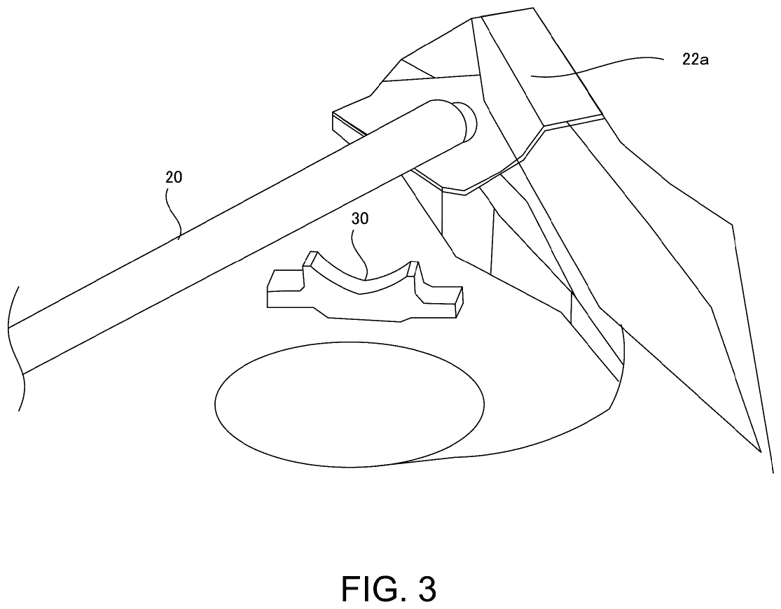

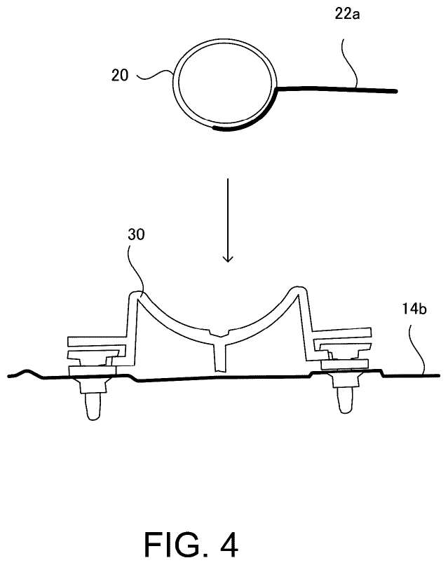

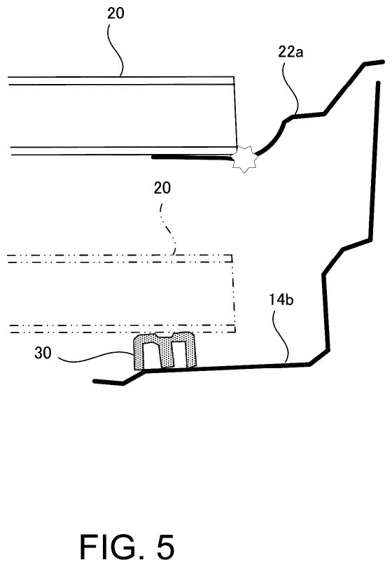

FIGS. 3, 4, and 5 show the positional relationship between the door beam 20 and the protective member 30. FIG. 3 shows a diagonal view, FIG. 4 shows a B-B section in FIG. 1, and FIG. 5 shows a C-C section in FIG. 1.

It may be clear from these figures, the protective member 30 is provided on the surface of the inner panel 14, the surface is located in the interior side of the vehicle near the front extension 22a. The protective member 30 is provided at a position corresponding to the door beam 20 on the surface of the inner panel 14. Therefore, the protective member 30 can catch the door beam 20 when the outer panel 16 moves toward the interior due to side impact, causing the front extension 22a to break and the door beam 20 to move toward the interior. In other words, as shown in FIG. 5, when the door beam 20 moves as indicated by the double-dashed line in FIG. 4, the door beam 20 impacts the protective member 30. Since the protective member 30 is made of resin and has a cavity inside, it deforms to absorb the impact. Therefore, the inner panel 14 can be prevented from being destroyed by the door beam 20. In particular, the protective member 30 is provided near the front extension 22a, which accommodates and secures the end of the door beam 20. Therefore, it can catch the tip of the door beam 20 in the event that the front extension 22a is broken, effectively preventing the tip of the door beam 20 from impacting the inner panel 14.

The protective member 30 should be away from the door beam 20 during normal situation, for example, for example, the protective member 30 is away from the door beam 20 about the radius of the door beam 20.

In this embodiment, the rear door (side door) is targeted, but the front door may also be targeted. The protective member 30 may be provided near the rear extension 22b or plural protective members 30 may be respectively provided near the front 22a and rear extension 22b.

### “Composition of Protective Component 30.”

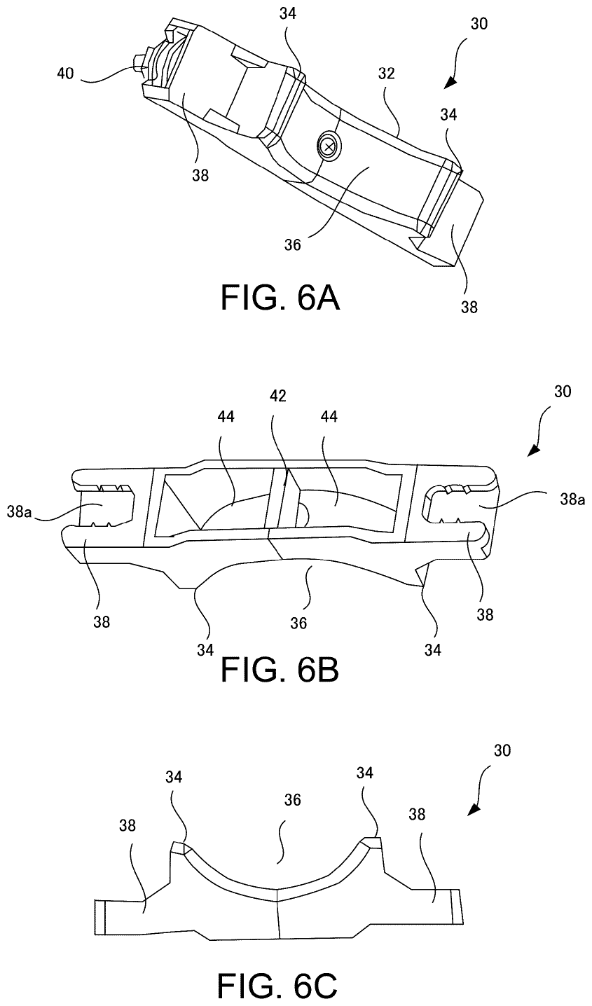

FIGS. 6A, 6B and 6C show the configuration of the protective member 30. FIG. 6A shows a front view, FIG. 6B shows a rear view, and FIG. 6C shows a side view. Here, the side of the protective member 30 that is fixed to the inner panel 14 is the rear side.

The protective member 30 is rectangular as a whole and has an interior cavity. In other words, the body 32 is closed when viewed from the front, and the interior cavity is not visible. The body 32 has a protruding portion 34 extending in the width direction at two locations across the center of the front side. The middle portion of the body 32 has an opposing recess 36 which has a semi-cylindrical shape and the opposing recess 36 opposes to the center most concave. Outside the protruding portion 34 are a pair of relatively thin plate-like side portions 38, into which the heads of bolts 40 are accommodated. The bolts 40 secure the body 32 to the inner panel 14.

When the protective member 30 is viewed from the rear, there is a cavity 44 divided into two by a wall 42 extending widthwise in the center. The side portion 38 has a housing recess 38a on the rear side that accommodates the head of the bolt 40.

The protective member 30 is made of resin, and the opposing recess 36 faces the door beam 20 to receive the door beam 20 when the door beam 20 moves toward the inner panel 14 to prevent damage to the inner panel 14. Although various types of resins can be used for the protective member 30, it is suitable to use a resin that has a relatively large deformation capacity under load.

In this embodiment, the protective member 30 is box-shaped with its upper surface closed and its lower surface open. This configuration ensures that the door beam 20 is received and proper deformation can be achieved.

1. A vehicle door comprising:
a pair of extensions respectively located at one end and the other end of an interior of the vehicle door;
a bar-shaped door beam having respective ends fixed to the pair of extensions, and which reinforces the vehicle door; and
a protective member which is provided inside the vehicle door, at a location corresponding to the bar-shaped door beam on an inner panel which constitutes a side surface, on a vehicle cabin side, of the vehicle door.

2. The vehicle door according to claim 1,
the protective member has an opposing recess in a portion facing the bar-shaped door beam.

3. The vehicle door according to claim 1,
the protective member is box-shaped with an interior cavity.

4. The vehicle door according to claim 1,
the protective member is made of resin.
